(19) United States
(12) Patent Application Publication
(10) Pub. No.: US 2018/0330156 A1
(43) Pub. Date: Nov. 15, 2018

(54) DETECTION OF CAPTION ELEMENTS IN DOCUMENTS

(71) Applicant: MICROSOFT TECHNOLOGY LICENSING, LLC, Redmond, WA (US)

(72) Inventor: Marko RAKITA, Novi Sad (RS)

(73) Assignee: MICROSOFT TECHNOLOGY LICENSING, LLC, Redmond, WA (US)

(21) Appl. No.: 15/592,469

(22) Filed: May 11, 2017

(51) Int. Cl. G06K 9/00

(52) U.S. Cl. CPC G06K 9/00463

(57) ABSTRACT

Technologies are described to detect captions in an unstructured or semi-structured document. Text regions may be defined by grouping letters based on proximity. Text regions that are not in close proximity of a graphical element may be filtered out. Candidate captions may be generated based on format, style, indentation, and/or location of text near graphical elements. Sequences of graphical elements and candidate captions may be ordered and a final combination of graphical elements and captions defining connections between captions and respective graphical element may be determined based on an analysis of relative positions and style relationships.

### BACKGROUND

Unstructured documents may contain little information about the structure of a document such as paragraphs, sections, caption vs. body text, etc. Thus, metadata may not identify which captions are related to which graphical (non-text) element. Documents created from an image (e.g., through optical character recognition) may also lack such information. Even in structured documents, which may have the metadata infrastructure to identify various elements and their connections, may not necessarily have the information if a user ignores the functionality and does not use identification features.

A document without identification of elements, specifically, captions and their connection to non-text elements may be difficult to process, for example, to reflow. When a document is viewed through different applications, display devices, or different user interface sites, it may need to be reflowed, that is, its contents rearranged for easier viewing (e.g., to avoid panning or resizing the displayed portion). If the structural information is not available, the document may not be reflowed preserving the content. For example, a graphical element and its corresponding caption may end up on different pages when the document is reflowed due to lack of connection information between the two.

### SUMMARY

This summary is provided to introduce a selection of concepts in a simplified form that are further described below in the Detailed Description. This summary is not intended to exclusively identify key features or essential features of the claimed subject matter, nor is it intended as an aid in determining the scope of the claimed subject matter.

Embodiments are directed to detection of captions in documents. In some examples, letters of textual content in the document may be grouped into regions based on proximity. The grouped textual content may then be filtered by discarding regions that are not adjacent to graphical elements. Candidate captions may be generated from the filtered textual content based on content, format, style, indentation, and/or location. Next, sequences of graphical elements and candidate captions may be ordered. Final combinations of graphical elements and captions may be determined based on analysis of relative positions and style relationships of the graphical element and the captions.

These and other features and advantages will be apparent from a reading of the following detailed description and a review of the associated drawings. It is to be understood that both the foregoing general description and the following detailed description are explanatory and do not restrict aspects as claimed.

### BRIEF DESCRIPTION OF THE DRAWINGS

FIGS. 1A and 1B are conceptual diagrams illustrating example networked environments of local and hosted implementation of detection of captions in documents, according to embodiments;

FIG. 2 is another conceptual diagram illustrating various structural elements in an example document;

FIG. 3 is a display diagram illustrating example components and actions in detection of captions in documents, according to embodiments;

FIG. 4 is a display diagram illustrating major actions and associated factors in detection of captions in documents, according to embodiments;

FIG. 5 is a display diagram illustrating major stages of detection of captions in documents in connection with a generated model, according to embodiments;

FIG. 6 is a simplified networked environment, where a system according to embodiments may be implemented;

FIG. 7 is a block diagram of an example computing device, which may be used to provide detection of captions in documents, according to embodiments; and

FIG. 8 is a logic flow diagram illustrating a process for detection of captions in documents, according to embodiments.

### DETAILED DESCRIPTION

As briefly described above, to detect captions in an unstructured or semi-structured document, text regions may be defined by grouping letters based on proximity. Text regions that are not in close proximity of a graphical element may be filtered out. Candidate captions may be generated based on content, format, style, indentation, and/or location of text near graphical elements. Sequences of graphical elements and candidate captions may be ordered and a final combination of graphical elements and captions defining connections between captions and respective graphical element may be determined based on an analysis of relative positions and style relationships.

As used herein, a document refers to any file with unstructured, structured, or semi-structured content elements. Non-limiting examples of documents may include word processing documents, presentation documents, spreadsheet documents, notebook documents, and similar ones. Content elements of a document may include text and graphical (or non-text) elements. Graphical elements may include, but are not limited to, graphics, charts, images, tables, interactive objects, and comparable ones.

In the following detailed description, references are made to the accompanying drawings that form a part hereof, and in which are shown by way of illustrations, specific embodiments, or examples. These aspects may be combined, other aspects may be utilized, and structural changes may be made without departing from the spirit or scope of the present disclosure. The following detailed description is therefore not to be taken in a limiting sense, and the scope of the present invention is defined by the appended claims and their equivalents.

While some embodiments will be described in the general context of program modules that execute in conjunction with an application program that runs on an operating system on a personal computer, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and comparable computing devices. Embodiments may also be practiced in distributed computing environments where tasks are performed by remote processing devices that are linked through a communications network. In a distributed computing environment, program modules may be located in both local and remote memory storage devices.

Some embodiments may be implemented as a computer-implemented process (method), a computing system, or as an article of manufacture, such as a computer program product or computer readable media. The computer program product may be a computer storage medium readable by a computer system and encoding a computer program that comprises instructions for causing a computer or computing system to perform example processes). The computer-readable storage medium is a computer-readable memory device. The computer-readable storage medium can for example be implemented via one or more of a volatile computer memory, a non-volatile memory, a hard drive, a flash drive, a floppy disk, or a compact disk, and comparable hardware media.

Throughout this specification, the term “platform” may be a combination of software and hardware components for detection of captions in documents. Examples of platforms include, but are not limited to, a hosted-service executed over a plurality of servers, an application executed on a single computing device, and comparable systems. The term “server” generally refers to a computing device executing one or more software programs typically in a networked environment. However, a server may also be implemented as a virtual server (software programs) executed on one or more computing devices viewed as a server on the network. More detail on these technologies and example operations is provided below.

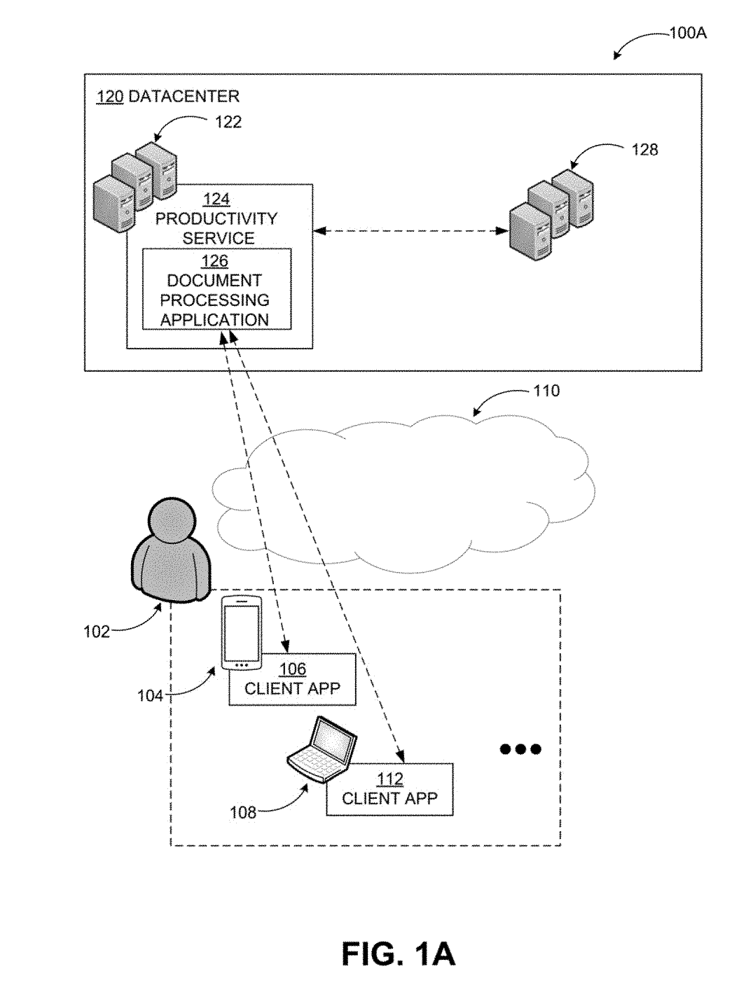

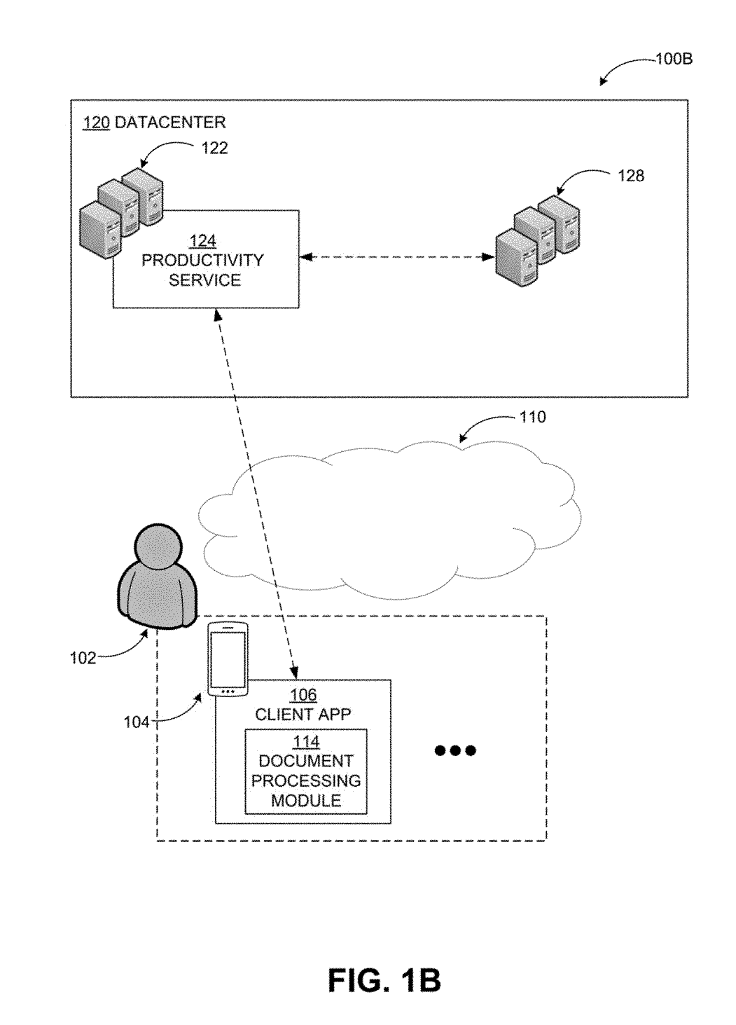

FIGS. 1A and 1B are conceptual diagrams illustrating example networked environments of local and hosted implementation of detection of captions in documents, according to embodiments.

In a diagram 200, a server 208 may execute a hosted service 202. The server 208 may include a physical server providing service(s) and/or application(s) to client devices. A service may include an application performing operations in relation to a client application and/or a subscriber, among others. The server 208 may include and/or is part of a workstation, a data, warehouse, a data center, and/or a cloud based distributed computing source, among others.

In a diagram 100A, a datacenter 120 may incorporate a number of server(s) such as a server cluster 122 and a server cluster 128. Each of the server dusters (122 and 128) may provide service(s) and application(s) (communicated through a network 110) for rendering by client devices (104 and 108) and other entity(s).

In an example scenario, a user 102 may consume a client application 106 provided by a productivity service 124 and rendered by a client device 104. An example of the client device 104 may include a smartphone. The user may also consume a client application 112 provided by the productivity service 124 and rendered by a client device 108. An example of the client device 108 may include a mobile computer such as a laptop. The client applications 106 and 112 may work in conjunction with document processing application 126 of the productivity service 124 and provide various services associated with one or more documents.

In an example scenario, the document processing application 126 may be a word processing application and the client applications 106 and 112 may be browsers used by user 102 to access the productivity-service 124. The user 102 may request to view an unstructured document. As the display sizes of the client devices 104 and 108 vary, the document may be reflowed by the productivity application 126 prior to being provided to the client applications 106 and 112 for rendering. To fellow the document properly without loss of content integrity, the document processing application 126 may detect captions and connect them to graphical elements in the document as described herein. In other examples, the document may be reflowed at one or more of the client applications 106 and 112.

Diagram 100B shows another system configuration, where instead of client applications accessing a document processing application at the productivity service, the client application 106 may include a document processing module 114, which may perform the caption detection, connection with graphical elements, and reflow of the document tasks. Productivity service 124 is one example implementation of embodiments. Embodiments may also be implemented in other hosted services such as a collaboration service, a communication service, and similar services or corresponding local applications.

The user 102 may interact with the client applications through a keyboard based input, a mouse based input, a voice based input, a pen based input, and/or a gesture based input, among others. The gesture based input may include one or more touch based actions such as a touch action, a swipe action, and/or a combination of each, among others.

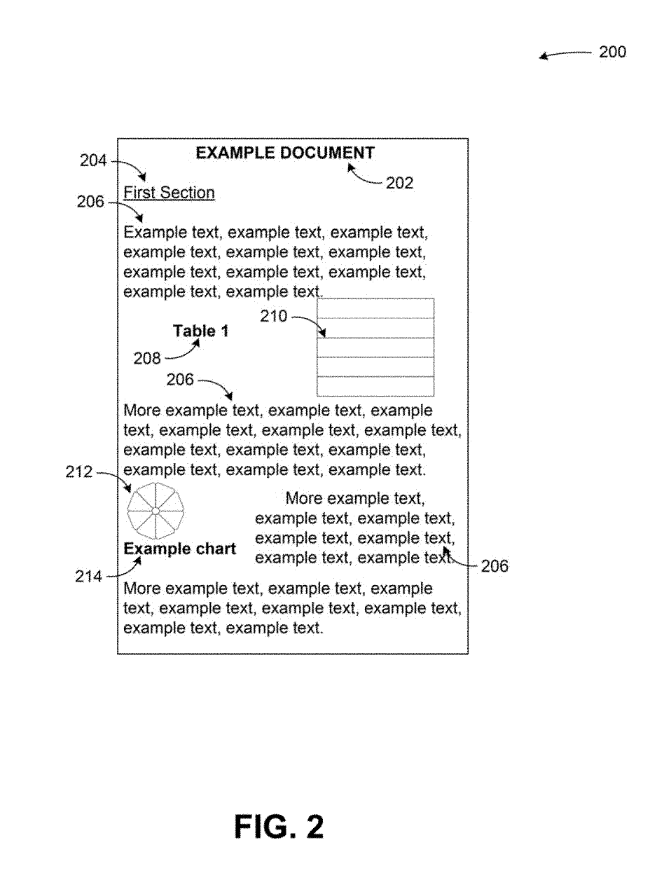

FIG. 2 is another conceptual diagram illustrating various structural elements in an example document.

Diagram 200 shows an example document 202 with various types of content. Example types of content in document 202 may include a header 204, body text 206, a first caption 208, a first graphical element (a table) 210, a second graphical element (chart) 212, and a second caption 214. In a structured document, each of these different types of content may be identified as such in the document metadata and the document may be reflowed or otherwise restructured without loss of integrity of the content. In an unstructured document or a semi-structured document, where the identification information may not be completely available, restructuring the document may be difficult or impossible since it may result in loss of integrity. For example, if the first caption 208 is misidentified as part of body text 206, it may be placed away from the graphical element 210 in the restructured document. Thus, detecting captions in the document and connecting them to corresponding graphical elements may enable reflow or restructuring of the document with preservation of content integrity.

The types of content shown in diagram 200 are for illustration purposes and do not represent a limitation on embodiments. Other types such as bulleted or numbered lists, intentional blank spaces, forms, etc. may also be used. Graphical elements may include graphics, charts, tables, images, interactive objects, and comparable non-text elements. Document 202 may be a word processing document, a presentation document, a spreadsheet document, a notebook document, a fixed-layout flat document (e.g., a portable document format document), and other similar documents.

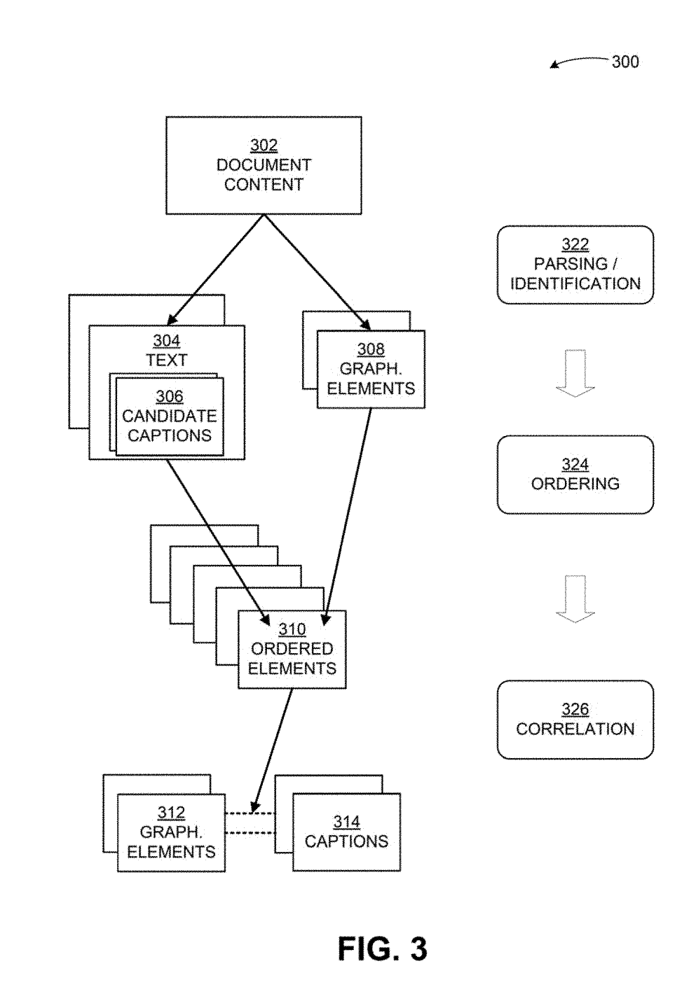

FIG. 3 is a display diagram illustrating-example components and actions in detection of captions in documents, according to embodiments.

As shown in diagram 300, content of a document 302 may be analyzed in a parsing/identification phase 322 resulting in text 304, which may include body text regions and captions 300, and graphical elements 308. Following ordering phase 324, ordered sequences of graphical elements and candidate captions 310 may be obtained by filtering out text regions away from graphical elements and selecting candidate captions and graphical elements based on proximity. The correlation phase 326 may yield final combinations of graphical elements 312 and captions 314 defining connections between the captions and respective graphical element based on an analysis of relative positions and style relationships.

Captions provide brief explanation or additional information related to non-text elements in a document (table, graphic, formula, chart, image, etc.). Some types of documents may contain special elements meant to contain the captions but document creators may not be using those elements to insert a caption into the document, for example, they may simply type in the caption as normal text (e.g., body text) or they may insert a text box near the element. In order to manipulate the content of such documents or to properly read their structure, captions and their corresponding non-text elements need to be identified. A system according to embodiments may accomplish the identification of captions and their related graphical elements through the phases described above or variations thereof.

In addition to proximity (captions may be above, below, to the right, or to the left of the corresponding graphical element), captions may also be identified based on formatting (e.g., font type or size), style (bold, underlined, italicized, etc.), content, and indentation. These attributes may be used to distinguish the captions from other text (e.g., body text) and then combined with location information in ordering with the graphical elements to arrive at a sequence of related captions and graphical elements. For example, a portion of the textual content starting with the word “Figure” may be identified as a candidate caption.

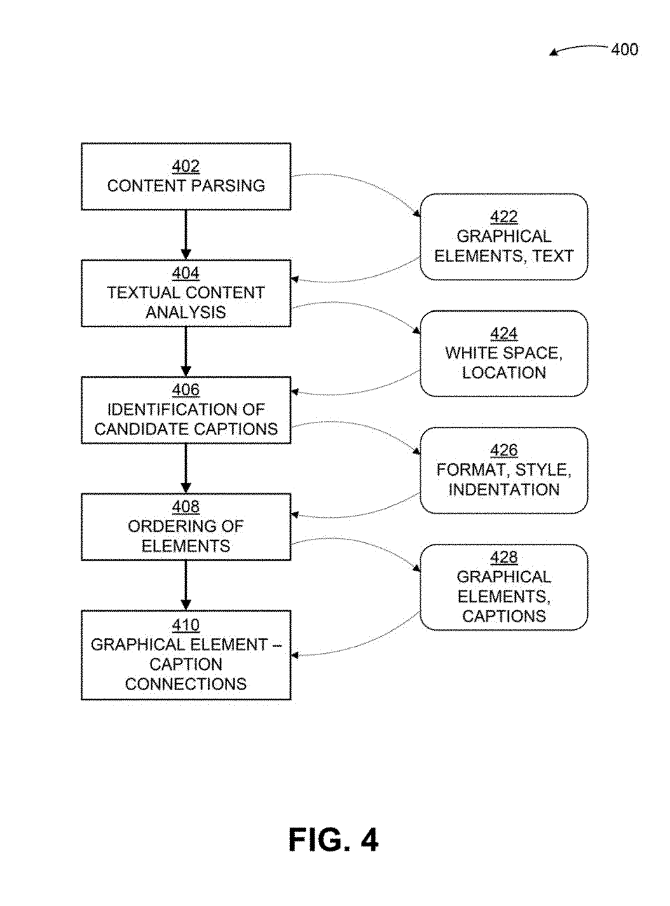

FIG. 4 is a display diagram illustrating major actions and associated factors in detection of captions in documents, according to embodiments.

As shown in diagram 400, during content parsing 402, graphical elements and text 422 may be identified as separate elements. Next, textual content may be analyzed (404) using white spaces, location of text regions (424), etc. resulting in identification of candidate captions 406 by distinguishing body text, headers, and other text types from candidate captions. Format, style, and location 426 of text may be used to further distinguish the captions and order sequences of graphical elements and candidate captions 408. A final sequence of graphical element and caption connections 410 may be determined using location information for candidate captions and graphical elements 428.

Analysis of text content may include grouping of letter into regions based on their proximity to each other. Text regions that are not near a graphical element or contain only whitespace text (large amounts of space) may be filtered out. Further text regions may be filtered based on heuristics, which may be obtained through machine learning or manual input. Such heuristics may be based on geometry and position of text regions and graphical elements near such text regions (for example, if graphical elements are only between text and no text is placed to the right or to the left of a graphical element).

In some examples, font size, height of text, style of text, whether a text portion (e.g., caption) is indented or not, etc. may be used to further filter text regions. After the various filtering options are exercised, the remaining text regions may be identified as candidate captions. In a second portion of the processing, sequences of graphical elements and candidate captions near those may be created. The sequences of possible graphical element—caption orders may be further analyzed based on position of the graphical elements and the candidate captions (as well as the other factors discussed above) to reduce the sequences to a final combination of graphical element—caption ordering.

Some documents may not have captions for a number of graphical elements. Thus, the sequences may be analyzed to match graphical elements with captions. If a document is semi-structured, that is, some structure information is available, such information may be used to supplement the analyses. If a document has multiple orderings, user feedback may be requested to resolve the conflict(s). In a system according to embodiments, several modes of precision may be achieved based on where in the process the analysis is performed. For example, in an environment where documents being processed have a consistent structure, strict sequence analysis may be selected, where graphical elements of same type have captions of same style or in same position. That approach may provide more rigorous filtering of false positive candidates, yielding higher precision. On the other hand, in an environment where documents being processed are badly structured and/or inconsistent, less strict sequence analysis may be used yielding less precision but higher recall.

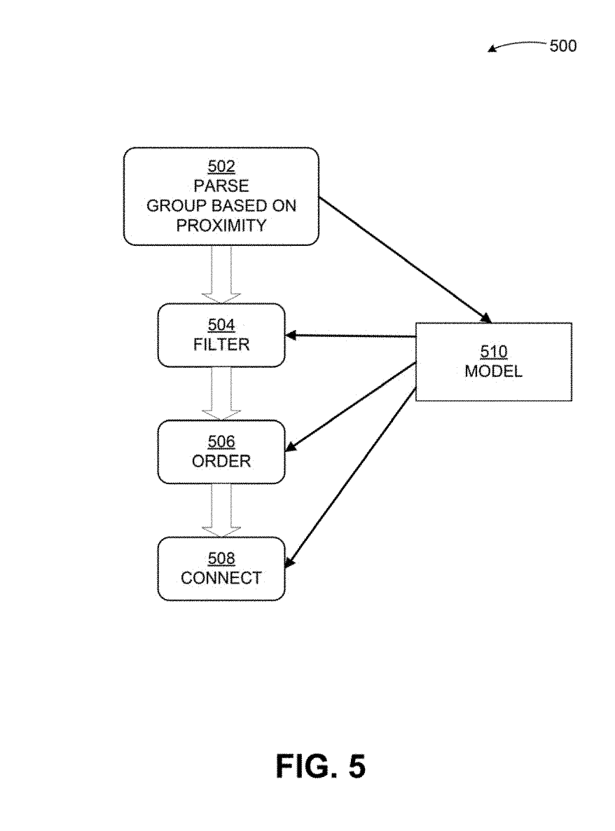

FIG. 5 is a display diagram illustrating major stages of detection of captions in documents in connection with a generated model, according to embodiments.

As discussed herein, multiple phases of analyses, filtering, and ordering may be performed to detect captions in a document and correlate the captions with corresponding graphical elements. As shown in diagram 500, some embodiments may employ a model for document structure. Model 510 may be generated based on input from parsing of the document content and grouping of text regions based on proximity (502). The model 510 may then be used for filtering out 504 text regions to obtain candidate captions, ordering 506 of candidate captions and graphical elements into possible sequences, and connecting 508 the graphical elements and corresponding captions in a final combination.

As discussed above, the hosted service or a locally installed application may be employed to detect captions and connect captions and graphical elements in a document. An increased performance and efficiency improvement with the hosted service or application may occur as a result of detecting captions in an unstructured or semi-structured document that may not identify captions in metadata. Additionally, detection of captions may reduce processor load, increase processing speed, conserve memory, and reduce network bandwidth usage.

Embodiments, as described herein, address a need that arises from a lack of detection of captions in unstructured documents. The actions/operations described herein are not a mere use of a computer, but address results that are a direct consequence of software used as a service offered to large numbers of users and applications.

The example scenarios and schemas in FIGS. 1A through 5 are shown with specific components, data types, and configurations. Embodiments are not limited to systems according to these example configurations. Detection of captions in a document may be implemented in configurations employing fewer or additional components in applications and user interfaces. Furthermore, the example schema and components shown in FIGS. 1A through 5 and their subcomponents may be implemented in a similar manner with other values using the principles described herein.

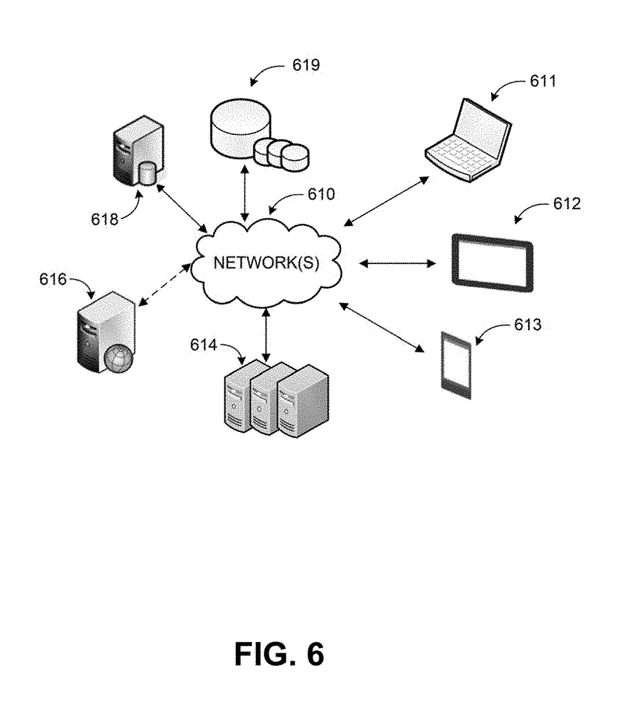

FIG. 6 is an example networked environment, where embodiments may be implemented. A hosted service configured to detect captions in documents may be implemented via software executed over one or more servers 614 such as a hosted service. The platform may communicate with client applications on individual computing devices such as a smart phone 613, a mobile computer 612, or desktop computer 611 (‘client devices’) through network(s) 610.

Client applications executed on any of the client devices 611-613 may facilitate communications via application(s) executed by servers 614, or on individual server 616. A hosted service may group letters of textual content in the document into regions based on proximity. The grouped textual content may then be filtered by discarding regions that are not adjacent to graphical elements. Candidate captions may be generated from the filtered textual content based on format, style, indentation, and/or location. Next, sequences of graphical elements and candidate captions may be ordered. Final combinations of graphical elements and captions may be determined based on analysis of relative positions and style relationships of the graphical element and the captions. The hosted service may store data associated with the captions and other elements of a document in data store(s) 619 directly or through database server 618.

Network(s) 610 may comprise any topology of servers, clients, Internet service providers, and communication media. A system according to embodiments may have a static or dynamic topology. Network(s) 610 may include secure networks such as an enterprise network, an unsecure network such as a wireless open network, or the Internet. Network(s) 610 may also coordinate communication over other networks such as Public Switched Telephone Network (PSTN) or cellular networks. Furthermore, network(s) 610 may include short range wireless networks such as Bluetooth or similar ones. Network(s) 610 provide communication between the nodes described herein. By way of example, and not limitation, network(s) 610 may include wireless media such as acoustic, RF, infrared and other wireless media.

Many other configurations of computing devices, applications, data sources, and data distribution systems may be employed to detect captions in a document. Furthermore, the networked environments discussed in FIG. 6 are for illustration purposes only. Embodiments are not limited to the example applications, modules, or processes.

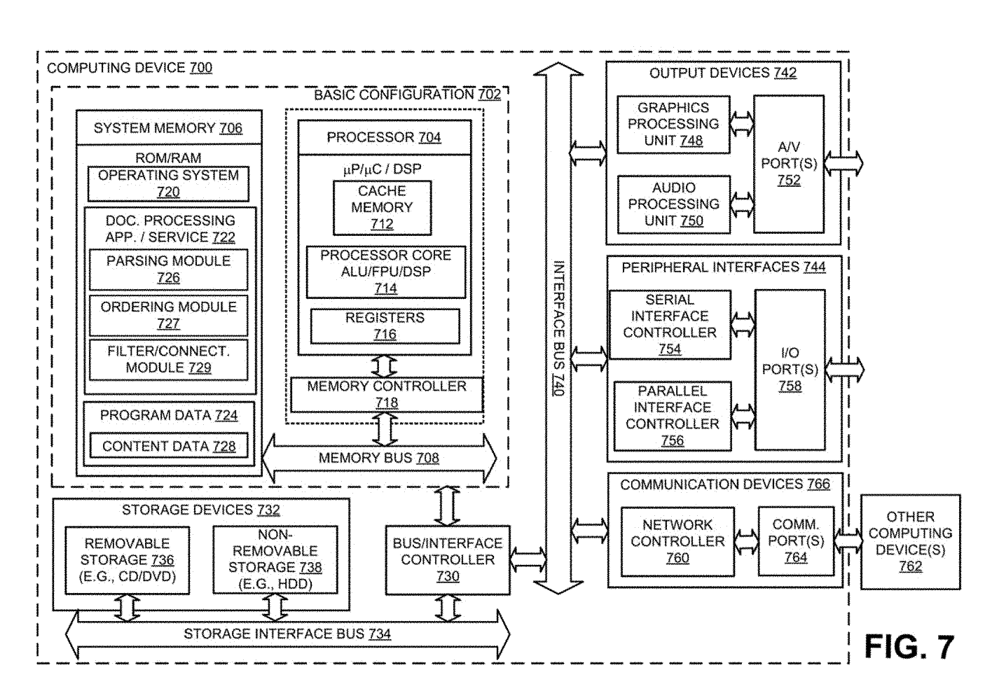

FIG. 7 is a block diagram of an example computing device, which may be used to detect captions in a document, according to embodiments.

For example, computing device 700 may be used as a server, desktop computer, portable computer, smart phone, special purpose computer, or similar device. In an example basic configuration 702, the computing device 700 may include one or more processors 704 and a system memory 706. A memory bus 708 may be used for communication between the processor 704 and the system memory 706. The basic configuration 702 may be illustrated in FIG. 7 by those components within the inner dashed line.

Depending on the desired configuration, the processor 704 may be of any type, including but not limited to a microprocessor (μP), a microcontroller (μC), a digital signal processor (DSP), or any combination thereof. The processor 704 may include one more levels of caching, such as a level cache memory 712, one or more processor cores 714, and registers 716. The example processor cores 714 may (each) include an arithmetic logic unit (ALU), a floating point unit (FPU), a digital signal processing core (DSP Core), or any combination thereof. An example memory controller 718 may also be used with the processor 704, or in some implementations, the memory controller 718 may be an internal part of the processor 704.

Depending on the desired configuration, the system memory 706 may be of any type including but not limited to volatile memory (such as RAM), non-volatile memory (such as ROM, flash memory, etc.), or any combination thereof. The system memory 706 may include an operating system 720, a document processing application or service 722, and a program data 724. The document processing application or service 722 may be a productivity service, a collaboration service, a word processing application, a presentation application, a notebook application, and similar ones, and include components such as a parsing module 726, and ordering module 727, and a filter/connection module 729. The document processing application or service 722 through its modules and other components may perform the tasks associated with detection of captions in documents. Program data 724 may include, among others, content data 728.

Input to and output out of the document processing application or service 722 may be transmitted through a communication module associated with the computing device 700. An example of the communication module may include a communication device 766 that may be communicatively coupled to the computing device 700. The communication module may provide wired and/or wireless communication. The program data 724 may also include, among other data, state data 728, or the like, as described herein. The state data 728 may include a do not disturb state, a start time, a duration, among others.

The computing device 700 may have additional features or functionality, and additional interfaces to facilitate communications between the basic configuration 702 and any desired devices and interfaces. For example, a bus/interface controller 730 may be used to facilitate communications between the basic configuration 702 and one or more data storage devices 732 via a storage interface bus 734. The data storage devices 732 may be one or more removable storage devices 736, one or more non-removable storage devices 738, or a combination thereof. Examples of the removable storage and the non-removable storage devices may include magnetic disk devices, such as flexible disk drives and hard-disk drives (HDDs), optical disk drives such as compact disk (CD), drives or digital versatile disk (DVD) drives, solid state drives (SSDs), and tape drives, to name a few. Example computer storage media may include volatile and nonvolatile, removable, and non-removable media implemented in any method or technology for storage of information, such as computer-readable instructions, data structures, program modules, or other data.

The system memory 706, the removable storage devices 736 and the non-removable storage devices 738 are examples of computer storage media. Computer storage media includes, but is not limited to, RAM, ROM, EEPROM, flash memory or other memory technology, CD-ROM, digital versatile disks (DVDs), solid state drives, or other optical storage, magnetic cassettes, magnetic tape, magnetic disk storage or other magnetic storage devices, or any other medium which may be used to store the desired information and which may be accessed, by the computing device 700. Any such computer storage media may be part of the computing device 700.

The computing device 700 may also include an interface bus 740 for facilitating communication from various interface devices (for example, one or more output devices 742, one or more peripheral interfaces 744, and one or more communication devices 766) to the basic configuration 702 via the bus/interface controller 730. Some of the example output devices 742 include a graphics processing unit 748 and an audio processing unit 750, which may be configured to communicate to various external devices such as a display or speakers via one or more A/V ports 752. One or more example peripheral interfaces 744 may include a serial interface controller 754 or a parallel interface controller 756, which may be configured to communicate with external devices such as input devices (for example, keyboard, mouse, pen, voice input device, touch input device, etc.) or other peripheral devices (for example, printer, scanner, etc.) via one or more I/O ports 758. An example of the communication device(s) 766 includes a network controller 760, which may be arranged to facilitate communications with one or more other computing devices 762 over a network communication link via one or more communication ports 764. The one or more other computing devices 762 may include servers, computing devices, and comparable devices.

The network communication link may be one example of a communication media. Communication media may typically be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include both storage media and communication media.

The computing device 700 may be implemented as a part of a general purpose or specialized server, mainframe, or similar computer, which includes any of the above functions. The computing device 700 may also be implemented as a personal computer including both laptop computer and non-laptop computer configurations. Additionally, the computing device 700 may include specialized hardware such as an application-specific integrated circuit (ASIC), a field programmable gate array (FPGA), a programmable logic device (PLD), and/or a free form logic on an integrated circuit (IC), among others.

Example embodiments may also include methods to detect captions in documents. These methods can be implemented in any number of ways, including the structures described herein. One such way may be by machine operations, of devices of the type described in the present disclosure. Another optional way may be for one or more of the individual operations of the methods to be performed in conjunction with one or more human operators performing some of the operations while other operations may be performed by machines. These human operators need not be collocated with each other, but each can be only with a machine that performs a portion of the program. In other embodiments, the human interaction can be automated such as by pre-selected criteria that may be machine automated.

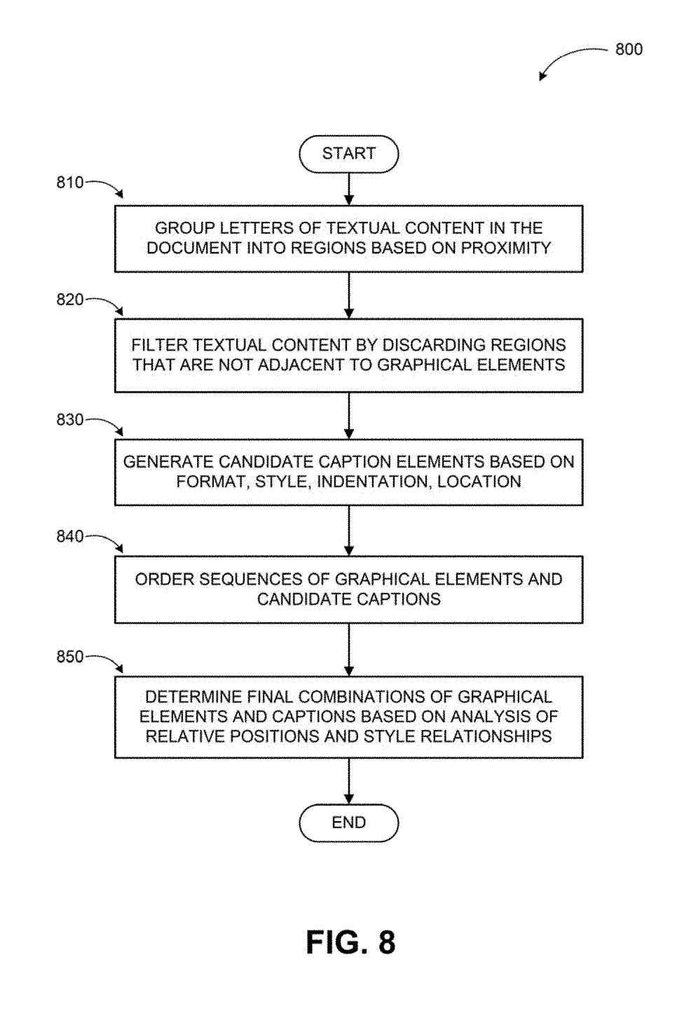

FIG. 8 is a logic flow diagram illustrating a process for detection of captions in a document, according to embodiments. Process 800 may be implemented on a computing device, such as the computing device 700 or another system.

Process 800 begins with operation 810, where a document processing application or service may group letters of textual content in the document into regions based on proximity. At operation 820, the grouped textual content may then be filtered by discarding regions that are not adjacent to graphical elements. At operation 830, candidate captions may be generated from the filtered textual content based on format, style, indentation, and/or location. At operation 840, sequences of graphical elements and candidate captions may be ordered. Final combinations of graphical elements and captions may be determined at operation 850 based on analysis of relative positions and style relationships of the graphical element and the captions.

The operations included in process 800 is for illustration purposes. Detection of captions in a document may be implemented by similar processes with fewer or additional steps, as well as in different order of operations using the principles described herein. The operations described herein may be executed by one or more processors operated on one or more computing devices, one or more processor cores, specialized processing devices, and/or general purpose processors, among other examples.

According to examples, a means for detecting captions in a document is described. The means may include a means for identifying textual content and graphical elements in the document; a means for grouping letters of the textual content in the document into text regions based on proximity; a means for filtering the textual content by discarding a subset of the text regions that are not adjacent to the graphical elements; a means for generating candidate captions based on one or more attributes of remaining text regions; a means for ordering sequences of the graphical elements and the candidate captions; and a means for determining a final combination of the graphical elements and corresponding captions based on an analysis of relative positions and style relationships in the ordered sequences.

According to some examples, a method executed on a computing device to detect captions in a document is described. The method may include identifying textual content and graphical elements in the document; grouping letters of the textual content in the document into text regions based on proximity; filtering the textual content by discarding a subset of the text regions that are not adjacent to the graphical elements; generating candidate captions based on one or more attributes of remaining text regions; ordering sequences of the graphical elements and the candidate captions; and determining a final combination of the graphical elements and corresponding captions based on an analysis of relative positions and style relationships in the ordered sequences.

According to other examples, generating the candidate captions based on the one or more attributes of the remaining text regions may include analyzing one or more of a format, a content, a style, an indentation, and a location of the remaining text regions. Grouping the letters of the textual content in the document into the text regions based on the proximity may include combining letters in contiguous sections and comparing locations of the combined letters in the contiguous sections to locations of the graphical elements. Ordering the sequences of the graphical elements and the candidate captions may include associating each graphical element with one or more candidate caption in a proximity of each graphical element. The proximity of each graphical element may include above, below, to a right of, or to a left of each graphical element.

According to further examples, the method may also include if one or more graphical elements are not associated with a corresponding caption, determining the final combination of the graphical elements and the corresponding captions by removing the one or more graphical elements from the ordered sequences. The method may further include if the document is semi-structured, employing available structure information to supplement one or more of the grouping, the filtering, the generating of the candidate captions, and the ordering of the sequences. The graphical elements may include one or more of a graphic, a chart, a table, an image, an interactive object, a formula. The method may also include storing the final combination in document metadata such that the document is enabled to reflowed based on the metadata without loss of content integrity.

According to other examples, a computing device for detection of captions in a document is described. The computing device may include a communication interface configured to facilitate communication between the computing device and one or more other computing devices; a memory configured to store instructions; and a processor coupled to the memory and the communication interface, the processor executing a document processing application in conjunction with the instructions stored in the memory. The document processing application may identify textual content and graphical elements in the document; group letters of the textual content in the document into text regions based on proximity; filler the textual content by discarding a subset of the text regions that are not adjacent to the graphical elements; generate candidate captions based on one or more of a format, a content, a style, an indentation, and a location of the remaining text regions; order sequences of the graphical elements and the candidate captions; and determine a final combination of the graphical elements and corresponding captions based on an analysis of relative positions and style relationships in the ordered sequences.

(1) According to some examples, the document processing application may be configured to filter the textual content based on one or more heuristics. The one or more heuristics may be obtained through machine learning or manual input. The one or more heuristics may be based on a geometry and a position of the text regions and the graphical elements. The document processing application may generate the candidate captions based on distinguishing the candidate captions from non-caption text regions based on one or more of the format, the style, the indentation, and the location of the remaining text regions.

According to other examples, the non-caption text regions may include one of a body text, a header, a title, a bulleted list, and a numbered list. The document processing application may be further configured to if one or more graphical elements are not associated with a corresponding caption, determine the final combination of the graphical elements and the corresponding captions by removing the one or more graphical elements from the ordered sequences; and if the document is semi-structured, employ available structure information to supplement one or more of grouping, filtering, generating of the candidate captions, and ordering of the sequences. The document may be a word processing document, a presentation document, a notebook document, or a spreadsheet document.

According to further examples, a server for detection of captions in a document is described. The server may include a communication interface configured to facilitate communication between the server and one or more client devices; a memory configured to store instructions; and a processor coupled to the memory and the communication interface, the processor executing a document processing service in conjunction with the instructions stored in the memory. The document processing service may be configured to identify textual content and graphical elements in the document; group letters of the textual content in the document into text regions based on proximity; filter the textual content by discarding a subset of the text regions that are not adjacent to the graphical elements; generate candidate captions based on one or more of a format, a content, a style, an indentation, and a location of the remaining text regions; order sequences of the graphical elements and the candidate captions; determine a final combination of the graphical elements and corresponding captions based on an analysis of relative positions and style relationships in the ordered sequences; and provide the final combination in metadata of the document to a client application such that the document is enabled to be reflowed without loss of content.

According to yet other examples, the document processing service may be configured to generate a model for a document structure based on parsing of the document content and the text regions. The model may be employed for one or more of filtering the text regions, ordering the sequences of the candidate captions and the graphical elements, and determining the final combination.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

What is claimed is:

1. A method executed on a computing device to detect captions in a document, the method comprising:
identifying textual content and graphical elements in the document;
grouping letters of the textual content in the document into text regions based on proximity;
filtering the textual content by discarding a subset of the text regions that are not adjacent to the graphical elements;
generating candidate captions based on one or mom attributes of remaining text regions;
ordering sequences of the graphical elements and the candidate captions; and
determining a final combination of the graphical elements and corresponding captions based on an analysis of relative positions and style relationships in the ordered sequences.

2. The method of claim 1, wherein generating the candidate captions based on the one or more attributes of the remaining text regions comprises:
analyzing one or more of a format, a content, a style, an indentation, and a location of the remaining text regions.

3. The method of claim 1, wherein grouping the letters of the textual content in the document into the text regions based on the proximity comprises:
combining letters in contiguous sections; and
comparing locations of the combined letters in the contiguous sections to locations of the graphical elements.

4. The method of claim 1, wherein ordering the sequences of the graphical elements and the candidate captions comprises:
associating each graphical element with one or more candidate caption in a proximity of each graphical element.

5. The method of claim 1, wherein the proximity of each graphical element includes one of above, below, to a right of and to a left of each graphical element.

6. The method of claim 3, further comprising:
if one or more graphical elements are not associated with a corresponding caption, determining the final combination of the graphical elements and the corresponding captions by removing the one or more graphical elements from the ordered sequences.

7. The method of claim 1, further comprising:
if the document is semi-structured, employing available structure information to supplement one or more of the grouping, the filtering, the generating of the candidate captions, and the ordering of the sequences.

8. The method of claim 1, wherein the graphical elements include one or more of a graphic, a chart, a table, an image, an interactive object, a formula.

9. The method of claim 1, further comprising:
storing the final combination in document metadata such that the document is enabled to reflowed based on the metadata without loss of content integrity.

10. A computing device for detection of captions in a document, the computing device comprising:
a communication interface configured to facilitate communication between the computing device and one or more other computing devices;
a memory configured to store instructions; and
a processor coupled to the memory and the communication interface, the processor executing a document processing application in conjunction with the instructions stored in the memory, wherein the document processing application is configured to:
identify textual content and graphical elements in the document;
group letters of the textual content in the document into text regions based on proximity;
filter the textual content by discarding a subset of the text regions that are not adjacent to the graphical elements;
generate candidate captions based on one or more of a format, a content, a style, an indentation, and a location of the remaining text regions;
order sequences of the graphical elements and the candidate captions; and
determine a final combination of the graphical elements and corresponding captions based on an analysis of relative positions and style relationships in the ordered sequences.

11. The computing device of claim 10, wherein the document processing application is configured to filter the textual content based on one or more heuristics.

12. The computing device of claim 11, wherein the one or more heuristics are obtained through machine learning or manual input.

13. The computing device of claim 12, wherein the one or more heuristics are based on a geometry and a position of the text regions and the graphical elements.

14. The computing of claim 10, wherein the document processing application is configured to generate the candidate captions based on distinguishing the candidate captions from non-caption text regions based on one or more of the format, the style, the indentation, and the location of the remaining text regions.

15. The computing of claim 14, wherein the non-caption text regions include one of a body text, a header, a title, a bulleted list, and a numbered list.

16. The computing device of claim 10, wherein the document processing application is further configured to:
if one or more graphical elements are not associated with a corresponding caption, determine the final combination of the graphical elements and the corresponding captions by removing the one or more graphical elements from the ordered sequences; and
if the document is semi-structured, employ available structure information to supplement one or more of grouping, filtering, generating of the candidate captions, and ordering of the sequences.

17. The computing device of claim 10, wherein the document is one of a word processing document, a presentation document, a notebook document, and a spreadsheet document.

18. A server for detection of captions in a document, the server comprising:
a communication interface configured to facilitate communication between the server and one or more client devices;
a memory configured to store instructions; and
a processor coupled to the memory and the communication interface, the processor executing a document processing service in conjunction with the instructions stored in the memory, wherein the document processing service is configured to:
identify textual content and graphical elements in the document;
group letters of the textual content in the document into text regions based on proximity;
filter the textual content by discarding a subset of the text regions that are not adjacent to the graphical elements;
generate candidate captions based on one or more of a format, a content, a style, an indentation, and a location of the remaining text regions;
order sequences of the graphical elements and the candidate captions;
determine a final combination of the graphical elements and corresponding captions based on an analysis of relative positions and style relationships in the ordered sequences; and
provide the final combination in metadata of the document to a client application such that the document is enabled to be reflowed without loss of content.

19. The server of claim 18, wherein the document processing service is configured to generate a model for a document structure based on parsing of the document content and the text regions.

20. The server of claim 19, wherein the model is employed for one or more of filtering the text regions, ordering the sequences of the candidate captions and the graphical elements, and determining the final combination.
